(19) United States
(12) Patent Application Publication
(10) Pub. No.: US 2008/0062575 A1
(43) Pub. Date: Mar. 13, 2008

(54) Magnetic Recording Medium, Method For Production Thereof And Magnetic Recording And Reproducing Device Using The Medium

(75) Inventor: Kenji Shimizu, Chiba (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., TOKYO (JP)

(21) Appl. No.: 11/628,667

(22) PCT Filed: Jun. 7, 2005
(86) PCT No.: PCT/JP05/10744

§ 371 Date: Feb. 27, 2007

Related U.S. Application Data
(60) Provisional application No. 60/578,849, filed on Jun. 14, 2004.

(30) Foreign Application Priority Data
Jun. 14, 2004 (JP) 2004-168640

(51) Int. Cl. G11B 5/33

(52) U.S. Cl. 360/314

(57) ABSTRACT

A magnetic recording medium includes at least a soft under layer, a perpendicular magnetic recording film and a protective film that are stacked on a nonmagnetic substrate. The nonmagnetic substrate is a disk of silicon having a diameter of 48 mm or less. A method for the production of the magnetic recording medium includes exerting a bias onto the silicon substrate when forming the protective film. A magnetic recording medium can be produced using the method. A magnetic recording and reproducing device can be produced using the magnetic recording medium and a magnetic head for recording and reproducing information in the magnetic recording medium. The magnetic head is a magnetic monopole head.

### CROSS REFERENCE TO RELATED APPLICATIONS

This application is an application filed under 35 U.S.C. §111(a) claiming the benefit pursuant to 35 U.S.C. §119(e)(1) of the filing dates of Provisional Application No. 60/578,849 filed Jun. 14, 2004 and Japanese Patent Application No. 2004-168640 filed Jun. 7, 2004 pursuant to 35 U.S.C. §111(b).

1. Technical Field

This invention relates to a magnetic recording medium, a method for the production thereof and a magnetic recording and reproducing device using the magnetic recording medium.

2. Background Art

The perpendicular magnetic recording system is suitable for exalting the surface recording density because it is enabled, by causing the axis of easy magnetization of a magnetic recording layer which has been heretofore turned in the in-plane direction of a medium to be turned in the perpendicular direction of the medium, to decrease the demagnetizing field in the neighborhood of the magnetization transition region which is the boundary between the recording bits and as a result attain the trend of being magnetostatically stabilized and enhanced in resistance to thermal fluctuation in accordance as the recording density is heightened.

When a backing substrate made of a soft magnetic material is interposed between the substrate and the perpendicular magnetic recording film, the resultant product functions as a so-called perpendicular two-layer medium and acquires a high recording ability. In this case, the soft magnetic under layer discharges the role of refluxing a recording magnetic field from a magnetic head and enables the recording and reproducing efficiency to be exalted.

Generally, the perpendicular magnetic recording medium is configured by stacking on a substrate a soft under layer (soft magnetic film), a foundation film for orienting the axis of easy magnetization of a magnetic layer perpendicularly to the surface of the substrate, a perpendicular magnetic recording film made of a Co alloy, and a protective film sequentially in the order mentioned. A perpendicular magnetic recording medium which uses an oxide-containing material in a granular structure as a perpendicular magnetic recording film has been proposed (refer, for example, to JP-A 2003-168207 or JP-A 2003-346334).

For the purpose of reducing to practice a magnetic recording and reproducing device which is capable of high density recording with a perpendicular magnetic recording system using a perpendicular two-layer medium, however, perfection of reliability is indispensable. The use of a glass substrate which is finding general acceptance entails the problem of suffering the components of the glass substrate to precipitate on the surface of the medium. This precipitation particularly gains in prominence when the perpendicular magnetic recording medium uses in its perpendicular magnetic recording film a material containing an oxide. Further, because the perpendicular magnetic recording film is in the granular structure, the precipitation of the elements other than those of the glass substrate, such as the elements used in the soft magnetic film and the orientation controlling film, pose a serious problem.

By augmenting the recording density to a high level, it is made possible even to provide a magnetic recording medium of a smaller diameter. When the substrate of a small diameter is used with the object of forming the protective film of DLS (diamond like carbon), for example, thereby solving the problem mentioned above, it becomes necessary to exert a bias to the substrate. When the substrate of a small diameter to be used is an insulating glass substrate, the exertion of a bias is at a disadvantage in seriously impairing the productivity. By using a silicon substrate, it is made possible to easily form a film of DLC without impairing the productivity.

The use of a granular structure containing an oxide for the perpendicular magnetic recording film, results in readily inducing the occurrence of corrosion due to a fault. Thus, the desirability of developing a magnetic recording medium which solves the problem and permits easy production has been finding recognition.

This invention has been initiated in the light of the state of affairs described above. It is aimed at providing a magnetic recording medium endowed with enhanced reliability and enabled to record and reproduce information in high density, a method for the production thereof, and a magnetic recording and reproducing device using the magnetic recording medium.

### DISCLOSURE OF THE INVENTION

For the purpose of accomplishing the object mentioned above, a first aspect of this invention is directed to a magnetic recording medium comprising a nonmagnetic substrate on which at least a soft under layer, a perpendicular magnetic recording film and a protective film are stacked, wherein the nonmagnetic substrate is a disk of silicon having a diameter of 48 mm or less.

A second aspect of the invention is directed to the magnetic recording medium according to the first aspect, wherein the nonmagnetic substrate is a disk of silicon having a diameter of 20 mm or less.

A third aspect of the invention is directed to the magnetic recording medium according to the first or second aspect, wherein the protective film is made of DLC (diamond like carbon).

A fourth aspect of the invention is directed to the magnetic recording medium according to any one of the first to third aspects, wherein the perpendicular magnetic recording film has a granular structure comprising at least Co, Pt and an oxide.

A fifth aspect of the invention is directed to the magnetic recording medium according to the fourth aspect, wherein the oxide is at least one member selected from the group consisting of SiO₂, Cr₂O₃, TiO, TiO₂ and Ta₂O₅.

A sixth aspect of the invention is directed to a method for the production of a magnetic recording medium comprising a silicon substrate on which at least a soft under layer, a perpendicular magnetic recording film and a protective film are stacked, which method comprises exerting a bias onto the silicon substrate when forming the protective film.

A seventh aspect of the invention is directed to the method according to the sixth aspect, wherein the silicon substrate is not heated.

An eighth aspect of the invention is directed to a magnetic recording medium produced using the method for the production of a magnetic recording medium according to the sixth or seventh aspect.

A ninth aspect of the invention is directed to a magnetic recording and reproducing device provided with a magnetic recording medium and a magnetic head for recording and reproducing information in the magnetic recording medium, wherein the magnetic head is a magnetic monopole head and the magnetic recording medium is the magnetic recording medium according to any one of the first to fifth aspects and the eighth aspect.

In a perpendicular magnetic recording medium furnished on a non-magnetic substrate at least with a soft under layer, a perpendicular magnetic recording film and a protective film, by forming this the non-magnetic substrate of a disk of silicon having a diameter of 48 mm or less, it has been made possible to easily manufacture a magnetic recording medium excelling in reliability and provide a magnetic recording medium capable of recording and reproducing information in high density, a method for the production thereof and a magnetic recording and reproducing device using the magnetic recording medium.

The above and other objects, characteristic features and advantages will become apparent to those skilled in the art from the description given herein below with reference to the accompanying drawings.

### BRIEF DESCRIPTION OF THE DRAWINGS

FIG. 1 is a cross section illustrating one example of the magnetic recording medium contemplated by this invention.

FIG. 2 is a schematic diagram illustrating one example of the magnetic recording and reproducing device contemplated by this invention.

### BEST MODE OF CARRYING OUT THE INVENTION

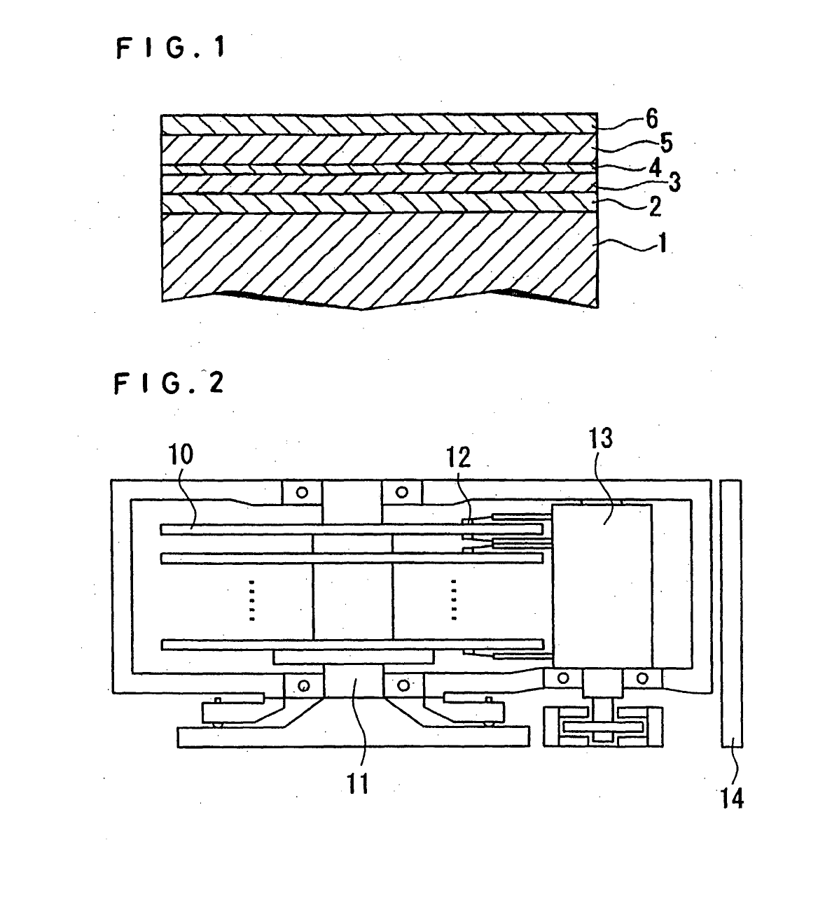

FIG. 1 depicts one example of the first embodiment of the magnetic recording medium of this invention. The magnetic recording medium illustrated in this diagram is configured by stacking on a silicon substrate 1 a soft magnetic film 2, an orientation controlling film 3, a perpendicular magnetic recording film 4, a protective film 5 and a lubricating film 6 sequentially in the order mentioned.

As a silicon substrate, a substrate using single crystal silicon and boron-doped silicon as raw materials can be used.

By using a silicon substrate possessing electrical conductivity, it is made possible to stably apply a bias to the substrate during the formation of the protective film.

Since the silicon substrate does not contain such an alkali metal as is entrained by a glass substrate and suffered to pose a problem in the case of using a glass substrate, the use of the silicon substrate is at an advantage in shunning the problem of inducing precipitation of the alkali metal on the surface of the medium.

The silicon substrate is preferably in a circular shape 48 mm or less (particularly 20 mm or less) in diameter. In the manufacture of a medium using a substrate of a large size exceeding 48 mm, it is made possible to attain easy exertion of a bias by performing the so-called re-grasping (the part for applying a bias to the substrate, such as the part at which the substrate during its conveyance contacts a holder, is shifted after the films have been formed on the substrate) or by utilizing a mechanism for establishing contact with the film-forming part of the substrate. When the size is 48 mm or less (particularly 20 mm or less), however, the re-grasping is not easily attained and the productivity is seriously impaired because of the small size of the diameter of the substrate. By using the silicon substrate, it is made possible to obviate the necessity for the mechanism for the re-grasping and attain manufacture of the medium infallibly without impairing the productivity.

The average surface roughness Ra of the silicon substrate is properly 1 nm or less, preferably 0.5 nm or less, and more preferably 0.3 nm or less because it fits the recording performed at a high recording density with the head kept in a state of low flying height.

Further, the minute waviness (Wa) of the surface is favorably 0.3 nm or less (preferably 0.25 nm or less) because it fits the recording performed at a high recording density with the head kept in a state of low flying height. The use of the silicon substrate which has an average surface roughness Ra in either or both of the chamfer part and the lateral face part of the end face thereof is 10 nm or less (preferably 9.5 nm or less) proves favorable from the standpoint of the flying height stability of the magnetic head. The minute waviness (Wa) can be determined as the average surface roughness in the measuring range of 80 μm by the use of a surface roughness determining device P-12 (KLA-Tencor Corp.).

The soft magnetic film is made of a soft magnetic material. As this material, any of the materials which contain Fe, Ni and Co may be used. It is particularly favorable to use a Co alloy which contains 80 at % or more of Co and at least one element selected from among Zr, Nb, Ta, Cr and Mo.

As concrete preferred examples of the material mentioned above, CoZr—, CoZrNb—, CoZrTa—, CoZrCr— and CoZrMo-based alloys may be cited.

The materials possessing microcrystalline structures, such as FeAlO, FeMgO, FeTaN and FeZrN, which invariably contain 60 at % or more of Fe and the materials possessing granular structures having minute crystal grains dispersed in a matrix are also available.

Besides those enumerated above, as concrete examples of the material for the soft magnetic film 2, FeCo alloys (such as FeCo and FeCoB), FeNi alloys (such as FeNi, FeNiMo, FeNiCr and FeNiSi), FeAl alloys (such as FeAl, FeAlSi, FeAlSiCr, FeAlSiTiRu and FeAlO), FeCr alloys (such as FeCr, FeCrTi and FeCrCu), FeTa alloys (such as FeTa, FeTaC and FeTaN), FeMg alloys (such as FeMgO), FeZr alloys (such as FeZrN), FeC alloys, FeN alloys, FeSi alloys, FeP alloys, FeNb alloys, FeHf alloys, FeB alloys, CoB alloys, CoP alloys, CoNi alloys (such as CoNi, CoNiB and CoNiP), and FeCoNi alloys (such as FeCoNi, FeCoNiP and FeCoNiB) may be cited.

The soft magnetic film is favorably formed of an amorphous structure or a microcrystalline structure. The reason for the preference of the amorphous structure or the microcrystalline structure is that the structure is made good in the surface roughness to thereby avoid deterioration of the crystal orienting property of the perpendicular magnetic recording film which is disposed thereon.

The coercive force Hc of the soft magnetic film is properly 20 Oe or less (preferably 10 Oe or less). Incidentally, 1 Oe is approximately 79 A/m.

The saturated magnetic flux density Bs of the soft magnetic foundation film 2 is properly 0.6 T or more (preferably 1 T or more).

Further, the total of the product Bs·t (T·nm) of the saturated magnetic flux density Bs (T) of the soft magnetic film multiplied by the thickness t (nm) of the soft magnetic film which is used in the soft under layer is properly 20 T·nm or more (preferably 40 T·nm or more). If the product Bs·t falls short of the lower limit of the range mentioned above, the shortage will be at a disadvantage in deteriorating the OW characteristic property.

The thickness t (nm) of the soft magnetic film to be used for the soft under layer is favorably 120 nm or less (preferably 80 nm or less). If the thickness of the soft magnetic film exceeds the upper limit of the range mentioned above, the overage will be at a disadvantage in inducing deterioration of surface properties, resulting in degradation of characteristic properties and deterioration of productivity.

As means to form the soft magnetic film, the sputtering method and the plating method are available.

The surface of the soft magnetic film (the surface on the side of the orientation controlling film) in the uppermost layer may result from partial or complete oxidation of the material which forms the soft magnetic film. That is, the material forming the soft magnetic film may be partially oxidized on the surface of the soft magnetic film in the uppermost layer and the neighborhood thereof or the oxide of the material mentioned above may be formed and disposed instead.

The soft magnetic film 2 is favorably formed in a stacked structure. By interposing Ru between the stacked soft magnetic films, it is made possible to perform antiferromagnetic bonding of the soft magnetic films perpendicularly opposed across the Ru film. The thickness of the Ru film is favorably in the range of 0.6 nm to 1 nm.

It is also permissible to interpose an antiferromagnetic film, such as of MnIr or MnFe, between the silicon substrate and the soft magnetic film. This interposition is intended to induce switched connection between the antiferromagnetic film and the soft magnetic film and consequently joggle the magnetization in one direction. This magnetization is favorably effected in the radial direction of the substrate. The MnIr— or MnFe-based alloy is capable of effecting switched connection between the soft magnetic film and the antiferromagnetic film by causing the soft magnetic film and the antiferromagnetic film to be formed in a magnetic field and further fortifying the switched connection by causing the formed films to be annealed or cooled in the magnetic field which has been used in the formation of the films. The switched connection proves favorable because it unifies the magnetic domain of the soft magnetic field and consequently exalts the magnetic stability to resist the external magnetic field.

The thickness of the antiferromagnetic film is favorably 3 nm or more and 10 nm or less in the MnIr-based alloy or 10 nm or more and 30 nm or less in the MnFe-based alloy. Particularly the thickness of the film of the MnIr-based alloy is in the range of 4 nm to 7 nm proves favorable because this film enables the magnetic field of switched connection to be enlarged sufficiently and possesses a small thickness in itself.

The soft magnetic crystalline foundation film is intended to enhance the antiferromagnetic crystallinity and enlarge the magnetic field of switched connection. The soft magnetic crystalline foundation film is favorably made of a material which possesses an fcc or hcp structure.

The orientation controlling film is intended to control the orientation and the particle diameter of the perpendicular magnetic recording film. As the material for the orientation controlling film, Ru or a Ru alloy proves favorable.

The thickness of the orientation controlling film is favorably 3 nm or more and 30 nm or less (particularly 10 to 20 nm). The reason for the preference of the range specified above for the thickness of the orientation controlling film is that the recording and reproducing property can be exalted without a sacrifice in the resolution of the reproduced signal because the perpendicular magnetic recording film has a good orientation property and the distance between the magnetic head and the soft under layer can be decreased during the course of recording.

The orientation controlling film may be in a granular structure formed of Ru and an oxide. As concrete examples of the oxide usable herein, SiO₂, Al₂O₃, Cr₂O₃, CoO and Ta₂O₅ may be cited.

The perpendicular magnetic recording film has the axis of easy magnetization thereof directed mainly perpendicularly to the substrate and favorably possesses a granular structure formed of at least Co, Pt and an oxide.

Particularly, the granular structure is favorably formed of CoPt plus oxide, such as SiO₂, TiO, TiO₂, ZrO₂, Cr₂O₃, CoO and Ta₂O₅. Particularly, the Pt content of the granular structure is favorably 10 at % or more and 22 at % or less (preferably 13 at % or more and 20 at % or less). As means to produce the granular structure, a method which comprises adding an oxide to a target and forming a film of the product of this addition and a method which comprises adding oxygen to a CoPt alloy during the formation of a film of this alloy and forming a film of the resultant product of addition by the sputtering technique are available.

The expression “directed mainly perpendicularly” is directed toward a perpendicularly magnetic recording film in which the coercive force Hc (P) in the perpendicular direction and the coercive force Hc (L) in the in-plane direction satisfy this relation, Hc (P)>Hc (L).

If the Pt content falls short of the lower limit of the range specified above, the shortage will be at a disadvantage in rendering the effect of enhancing the recording and reproducing property insufficient, decreasing the ratio of the residual magnetization (Mr) and the saturated magnetization (Ms), i.e. the ratio of Mr/Ms, and deteriorating the resistance to the thermal fluctuation. If the Pt content exceeds the upper limit of the range specified above, the overage will be at a disadvantage in increasing the noise.

The perpendicular magnetic recording film may be formed in a one-layer structure made of a material containing at least Co, Pt and an oxide or in a structure of two or more layers made of materials different in composition.

The thickness of the perpendicular magnetic recording film is favorably in the range of 5 to 20 nm (preferably in the range of 10 to 16 nm). When the perpendicular magnetic recording film has a thickness of 5 nm or more, it is at an advantage in enabling a magnetic recording and reproducing device to function suitably for high recording density because it is capable of acquiring a fully satisfactory magnetic flux and incapable of decreasing the output during the course of reproduction or suffering the output waveform to bury itself in the noise component. When the perpendicular magnetic recording film has a thickness of 20 nm or less, it is at an advantage in preventing the magnetic particles in the perpendicular magnetic recording film from being coarsened and shunning the possibility of inducing degradation of the recording and reproducing property, such as the increase of noise.

The coercive force of the perpendicular magnetic recording film is favorably 4000 (Oe) or more. If the coercive force falls short of 4000 (Oe), the shortage will be at a disadvantage in obstructing acquisition of the resolution necessary for high recording density and impairing the resistance to thermal fluctuation.

The ratio of the residual magnetization (Mr) and the saturated magnetization (Ms), namely the ratio Mr/Ms, of the perpendicular magnetic recording film is favorably 0.95 or more. If this ratio of Mr/Ms falls short of 0.95, the shortage will be at a disadvantage in impairing the resistance of the magnetic recording medium to thermal fluctuation.

The reverse magnetic domain kernel forming magnetic field (−Hn) of the perpendicular magnetic recording film is favorably 1000 or more. When the magnetic recording medium has the reverse magnetic domain kernel forming magnetic field (−Hn) thereof fall short of 1000, it is at a disadvantage in being deficient in the resistance to the thermal fluctuation.

The average particle diameter of the crystal particles in the perpendicular magnetic recording medium is favorably 4 nm or more and 8 nm or less. This average particle diameter can be determined by observing a sample of crystal particles of the perpendicular magnetic recording film under a transmission electron microscope (TEM) and subjecting the observed image to image processing.

The protective film is intended to protect the perpendicular magnetic recording film against corrosion and keep the magnetic head from inflicting damage to the surface of the medium when they are brought into contact and it is favorably made of DLC (diamond like carbon). The thickness of the protective layer is advantageously 1 nm or more and 5 nm or less from the viewpoint of the high recording density because this thickness permits a decrease in the distance between the head and the medium.

The lubricating film is favorably made of any of the heretofore known materials, such as perfluoropolyether, fluorinated alcohols and fluorinated carboxylic acids.

The magnetic recording medium of the present embodiment, namely the perpendicular recording medium which is furnished with a soft under layer, a perpendicular magnetic recording film and a protective film constitutes itself a magnetic recording medium having a small diameter and excelling in productivity because the nonmagnetic substrate mentioned above is a disk of silicon having a diameter of 48 mm or less. This magnetic recording medium excels in reliability as well.

FIG. 2 depicts an example of the magnetic recording and reproducing device using the magnetic recording medium described above. The magnetic recording and reproducing device illustrated in the diagram is provided with a magnetic recording medium 10, a medium driving part 11 for rotationally driving the magnetic recording medium 10, a magnetic head 12 for recording and reproducing information in the magnetic recording medium 10, a head driving part 13 and a recording and reproducing signal processing system 14. The recording and reproducing signal processing system 14 is adapted to process the data input therein and output the recording signal to the magnetic head 12 and process the reproducing signal from the magnetic head 12 and output the resultant data.

Now, the operation and effect of this invention will be clarified below with reference to examples. It should be noted, however, that this invention is not limited to the following examples.

### EXAMPLE 1

A cleaned silicon substrate (20 mm in diameter) was placed in a film-forming chamber of a DC magnetron sputtering device (made by Anelva Co. and sold under a product code of “C-3010”). The interior of the film-forming chamber was evacuated till the degree of vacuum reached 1×10⁻⁵ Pa. Then, 50 nm of 89Co-4Zr-7Nb (Co content 89 at %, Zr content 4 at %, and Nb content 7 at %), 0.8 nm of Ru and 50 nm of 89Co-4Zr-7Nb were placed on this silicon substrate and treated to form a soft magnetic film. Subsequently, 20 nm of Ru was made to form an orientation controlling film and 12 nm of 66Co-8Cr-18Pt-8SiO₂ was made to form a perpendicular magnetic recording film. In this while, the substrate was not heated at all.

Next, a protective film (DLC) of an amount of 4 nm was formed by the CVD method.

Then, a lubricating film of perfluoropolyether was formed by the dipping method to complete a magnetic recording medium.

### COMPARATIVE EXAMPLE 1

A magnetic recording medium was manufactured by following the procedure of Example 1 while using a glass substrate (crystallized glass) in the place of the silicon substrate.

### COMAPARATIVE EXAMPLE 2

A magnetic recording medium was manufactured by following the procedure of Example 1 while forming the protective film (non-DLC film) by the sputtering method instead.

The magnetic recording media obtained in the preceding example and comparative examples were rated for the recording and reproducing property and the reliability. The recording and reproducing property was rated using a read-write analyzer (made by GUZIK Corp. of the U.S. and sold under a product code of “RWA1632”) and a spin stand S1701MP.

The recording and reproducing property was rated using a head adapted to effect writing with a single magnetic pole and effect reproduction with a GMR element under the conditions of recording frequency having the signal (TAAo-p) set at a linear recording density of 120 kFCI and the noise set at a linear recording density of 720 kFCI. The SNR was calculated in accordance with the following formula.
SNR=20×log(TAAo−p/Noise)

The reliability was determined by the following method. A perpendicular magnetic recording medium manufactured was left standing in a circumstance kept at a high temperature of 60° C. and a high humidity of 80% for 120 hours and then shaken in 30 ml of ultrapure water for 30 minutes to extract Co and Li. The concentrations of Co and Li thus extracted were determined by the ICP emission spectroscopy. The results are shown in Table 1 below.

TABLE 1

| | |
|---|---|
| SNR | Extraction from water |

| | (dB) | Co (ng/cm²) | Li (ng/cm²) |
|---|---|---|---|
| Ex. 1 | 25.4 | 0.025 | 0 |
| Comp. Ex. 1 | 25.2 | 0.068 | 0.026 |
| Comp. Ex. 2 | 25.3 | 0.232 | 0 |

Example 1 was confirmed to shun elution of Li and exalt reliability greatly because it possessed an equal recording and reproducing property to Comparative Example 1, extracted Co only in a small amount and used a silicon substrate. It was also confirmed to extract Co only in a small amount and exalt reliability greatly because it possessed an equal recording and reproducing property to Comparative Example 2.

### INDUSTRIAL APPLICABILTY

As described above, this invention, in a perpendicular magnetic recording medium furnished on a nonmagnetic substrate with at least a soft under layer, a perpendicular magnetic recording film and a protective film, is enabled by using a disk of silicon 48 mm or less in diameter as the nonmagnetic substrate, to permit easy manufacture of a magnetic recording medium excelling in reliability and provide a magnetic recording medium capable of recording and reproducing information in high density, a method for the production thereof, and a magnetic recording and reproducing device using the magnetic recording medium.

1. A magnetic recording medium comprising a nonmagnetic substrate on which at least a soft under layer, a perpendicular magnetic recording film and a protective film are stacked, wherein the nonmagnetic substrate is a disk of silicon having a diameter of 48 mm or less.

2. A magnetic recording medium according to claim 1, wherein the nonmagnetic substrate is a disk of silicon having a diameter of 20 mm or less.

3. A magnetic recording medium according to claim 1, wherein the protective film is made of DLC (diamond like carbon).

4. A magnetic recording medium according to claim 1, wherein the perpendicular magnetic recording film has a granular structure comprising at least Co, Pt and an oxide.

5. A magnetic recording medium according to claim 4, wherein the oxide is at least one member selected from the group consisting of SiO₂, Cr₂O₃, TiO, TiO₂ and Ta₂O₅.

6. A method for the production of a magnetic recording medium comprising a silicon substrate on which at least a soft under layer, a perpendicular magnetic recording film and a protective film are stacked, comprising exerting a bias onto the silicon substrate when forming the protective film.

7. A method according to claim 6, wherein the silicon substrate is not heated.

8. A magnetic recording medium produced using the method for the production of a magnetic recording medium according to claim 6.

9. A magnetic recording and reproducing device provided with a magnetic recording medium and a magnetic head for recording and reproducing information in the magnetic recording medium, wherein the magnetic head is a magnetic monopole head and the magnetic recording medium is the magnetic recording medium according to claim 1.
